(19) United States
(12) Patent Application Publication
(10) Pub. No.: US 2022/0108288 A1
(43) Pub. Date: Apr. 7, 2022

(54) SYSTEM AND METHOD OF ENHANCING TIP MANAGEMENT

(71) Applicant: John CHOI, El Dorado Hills, CA (US)

(72) Inventor: John CHOI, El Dorado Hills, CA (US)

(21) Appl. No.: 17/491,798

(22) Filed: Oct. 1, 2021

Related U.S. Application Data
(60) Provisional application No. 63/086,233, filed on Oct. 1, 2020.

(51) Int. Cl. G06Q 20/10; G06Q 40/02; G06Q 10/10; G06Q 20/20; G06Q 20/40; H04L 29/08

(52) U.S. Cl. CPC G06Q 20/108; G06Q 40/02; G06Q 10/1053; H04L 67/26; G06Q 20/202; G06Q 20/40; G06Q 20/207; G06Q 10/1093

(57) ABSTRACT

A system and method of enhancing ‘tip’ or ‘gratuity’ management, herein referred to as a ‘Daily Tip Payment System’ (DTPS) is disclosed. One example embodiment is comprised of a software application (app), a data processor executing the app, and a cloud network. The software connects with an employer's existing point of sale (POS) platform used in retail settings (such as restaurants, etc.) and allows tips from cashless transactions to be seamlessly deposited directly into an service provider's bank account, prepaid debit card, or mobile payment app after each shift for a small fee. An object of the example embodiments of the invention is to streamline tip coordination and allocation for the employer and allow the service provider to receive tips more frequently and more conveniently.

### PRIORITY PATENT APPLICATION

This non-provisional patent application draws priority from U.S. provisional patent application Ser. No. 63/086,233; filed Oct. 1, 2020. This present non-provisional patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure as described below and in the drawings that form a part of this document: Copyright 2019-2021, John CHOI, All Rights Reserved.

### TECHNICAL FIELD

Example embodiments of the present invention generally relate to gratuity management, data processing systems, and cloud networks. More specifically, the disclosed example embodiments relate to a system and method for enhancing tip management for both employers and service providers.

### BACKGROUND

Today, tipping service providers in restaurants, bars, and other service businesses is very common around the world. While tipping remains popular, many customers now include tips in cashless transactions. However, this practice can present problems for employers who need to track and record tips for payroll accounting. Additionally, tipping in cashless transactions can be problematic for service providers who may not have access to their tips until the tips appear in their paycheck. What is needed is a system and method to enhance tip management for the benefit of employers, employees, and other service providers.

### SUMMARY

The system and method herein disclosed and described provides a solution for enhancing tip management. Example embodiments of the present invention address the change in business dynamics regarding cashless transactions. More consumers are using credit cards, debit cards, and mobile pay applications (Apps) to pay for services and goods, including TIPS. In most restaurant and service-based businesses, the TIPS earned by employees are tracked and monitored through the employer's point-of-sale (POS) system. While the POS allows the employer to cash-out employees' TIPS after each work shift, there are barriers that make this task difficult. Some of the barriers include: not having enough cash on hand, internal quality controls of maintaining cash on hand, and the amount of time it takes to reconcile and disburse TIPS to wages to each employee on a daily basis. As a result, most TIPS are paid out when employees receive their paycheck.

The DTPS of an example embodiment can eliminate the barriers that prevent employers from cashing out TIPS after each work shift, giving flexibility to employees to cash-out their TIPS as needed. DTPS will interact with any POS to extract TIPS data, make daily payments to employees who choose to cash-out their TIPS, import TIPS data back into the POS on the amount cashed out, automating the reconciliation process, provide detail reports to employers on all TIPS transactions, and provide each employee their activity report on TIPS.

Once the employer incorporates DTPS into their business, the employer can create a profile enabling them to obtain detailed reports of daily TIPS activities for all their employees or service providers. The employer profile will have certain requirements to choose. Employers can choose to have each cash out of TIPS transaction costs to be paid by them or the employee. The cost of each cash out transaction will vary on method of payment employees choose to receive such as direct deposit to their banking account, debit card, or mobile payment App. Employers will also need to choose if the cash out of TIPS will be subject to withholding FICA taxes. FICA taxes are Medicare and Social Security tax which currently equates to 7.65% of all wages and TIPS that employees are responsible for paying. Note that the employer is held responsible to collect and pay these taxes to the Internal Revenue Service.

Once the employer sets up the profile, then each participating employee can log in to the DTPS software app by registering on their computer and/or mobile device via the app. Once registered, employees will create a profile where they will also have certain requirements to choose. Employees will need to choose their method of receiving their TIPS by direct deposit to their bank account, debit card, or mobile payment App. If the employer's profile is to have the employees pay for each transaction of TIPS cash out, then the cost of each transaction will be stated on the method of payment the employee chooses to receive. If the employer's profile is to have the employer withhold FICA taxes on the TIPS cashed out, employees will be notified of such. This choice will reduce the amount of TIPS available to cash out by 7.65% for FICA taxes. If the employer's profile is to not have FICA taxes withheld on the TIPS cashed out, then the employees' profiles will be given a choice to withhold 7.65% for FICA taxes.

Therefore, one object of the example embodiments of the invention is to allow all cashless tips to be monitored at all times. The system tracks all cashless tips given to each service provider by customers and allows both the employer and the service provider to view tips as they accrue in real time.

Another object of the example embodiments of the invention is to allow employers to determine how and when tips are viewed. For example, the employer has the ability to allow service providers to view tips only after their shift has been completed to avoid any potential distractions while a service provider is on the job.

Another object of the example embodiments of the invention is to allow employers to determine the amount of tips that are dispersed and when tips are available to each service provider. For example, an employer may allow service providers (or a group of service providers) to receive their tips instantly when they are given, at the end of their shift, at the end of the week, or even at the end of the month. These allotments can be partial percentages or paid in full depending on the employer's preferences.

Another object of the example embodiments of the invention is to allow service providers to choose the account to which tip payments are transferred. For example, service providers can transfer tips directly into their bank account, debit card or choose from a wide array of existing payment accounts or payment applications (apps), such as Paypal™, Venmo™, etc.

Another object of the example embodiments of the invention is to provide tip out cash forecasting in real time. For example, if a number of service providers prefer to receive a cash payout after their shift ends, the example embodiment can determine how much cash is available in the drawer at any given moment. If the amount of cash on hand falls below an acceptable level to allow for tip payouts (as preset by the employer), the example embodiment can notify the service provider that a cash dispersal is unavailable at the moment and can offer other options, such as a bank transfer, etc.

Another object of the example embodiments of the invention is to provide a tips reporting feature. By use of this feature, employers can view all tip related activity of every service provider in real time with service provider ‘tip profiles.’ For example, a manager can log in to the system's website and pull up a tip profile for a service provider. The employer can view the quantity of tips the service provider has received, when the service provider requested a payout, and view payout confirmations and amounts with identification numbers for each transaction. Similarly, service providers can view their tip payout histories using a software application (app) of an example embodiment according to the level of access assigned by the service provider.

Another object of the example embodiments of the invention is to allow employers to determine how tip management will be made compliant with taxation laws. For example, a service provider may choose to withhold a certain percentage of tips from the service provider's paycheck to meet federal or state tax withholding requirements. The software app of an example embodiment can also allow service providers to deduct percentages of tip payouts for tax purposes.

Another object of the example embodiments of the invention is to allow employers to automatically divide shared tips equally among service providers. For example, service providers at a winery may share the total tips received in the tasting room each day. The software app of an example embodiment automatically divides cashless tips equally among the service providers and distributes the funds according to each service provider's preferences.

Another object of the example embodiments of the invention is to provide reporting snapshots or year-end summaries of tips broken out by service provider that can be used in performance evaluations.

Another object of the example embodiments of the invention is to provide notifications and reminders to employers and service providers. For example, if an employer allows service providers to only receive tips in cash payouts at the end of each shift and cash in the drawer is running low, the software app of an example embodiment can send an alert to the employer stating that the employer might consider making a bank run to obtain more cash to meet the tip payout requirements before the shift ends. Similarly, if a service provider fails to cash out their tips for an extended period of time, the software app of an example embodiment can remind the service provider of their balance.

It is briefly noted that upon a reading this disclosure, those of ordinary skill in the art will recognize various means for carrying out these intended features of the example embodiments of the invention as disclosed herein. As such, it is to be understood that other methods, applications, and systems adapted to the task may be configured to carry out these features and are therefore considered to be within the scope and intent of the present invention. With respect to the disclosure herein, it is to be understood that the example embodiments of the invention are not limited in their application to the details of construction and to the arrangement of the components in the descriptions or illustrated in the drawings herein. The example embodiments of the invention herein described are capable of other implementations and of being practiced and carried out in various ways, which will be obvious to those of ordinary skill in the art in view of the disclosure herein. Also, it is to be understood that the phraseology and terminology employed herein are for the purpose of description and should not be regarded as limiting.

As such, those of ordinary skill in the art will appreciate that the conception upon which this disclosure is based may readily be utilized as a basis for designing of other structures, methods and systems for carrying out the several purposes of the presently disclosed system. It is important, therefore, that the claims be regarded as including such equivalent construction and methodology insofar as they do not depart from the spirit and scope of the present invention.

### BRIEF DESCRIPTION OF THE DRAWINGS

The accompanying drawings, which are incorporated herein and form a part of the specification, illustrate some, but not the only or exclusive, examples of embodiments and/or features.

FIG. 1 shows a perspective view of the example embodiments of the invention in use.

FIG. 2 shows the process operations of the example embodiments of the invention.

FIG. 3 illustrates a system structure diagram showing an example embodiment represented as a Daily Tip Payment System (DTPS) in data communication with a POS and employer and employee access portals.

FIG. 4 illustrates a system structure diagram showing an example embodiment of the DTPS in data communication with a POS for receipt of tip information from the POS.

FIG. 5 illustrates a system structure diagram showing an example embodiment of the DTPS in data communication with a POS and providing data support for the employer and employees (or other service providers).

FIG. 6 illustrates a system structure diagram showing an example embodiment of the employee access portal or user interface provided by the DTPS.

FIG. 7 illustrates a system structure diagram showing an example embodiment of the employer access portal or user interface provided by the DTPS.

FIG. 8 is a processing flow diagram that illustrates example embodiments of methods as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the example embodiments of the invention are elements that are well-known in the prior art and will not be discussed in detail for this disclosure.

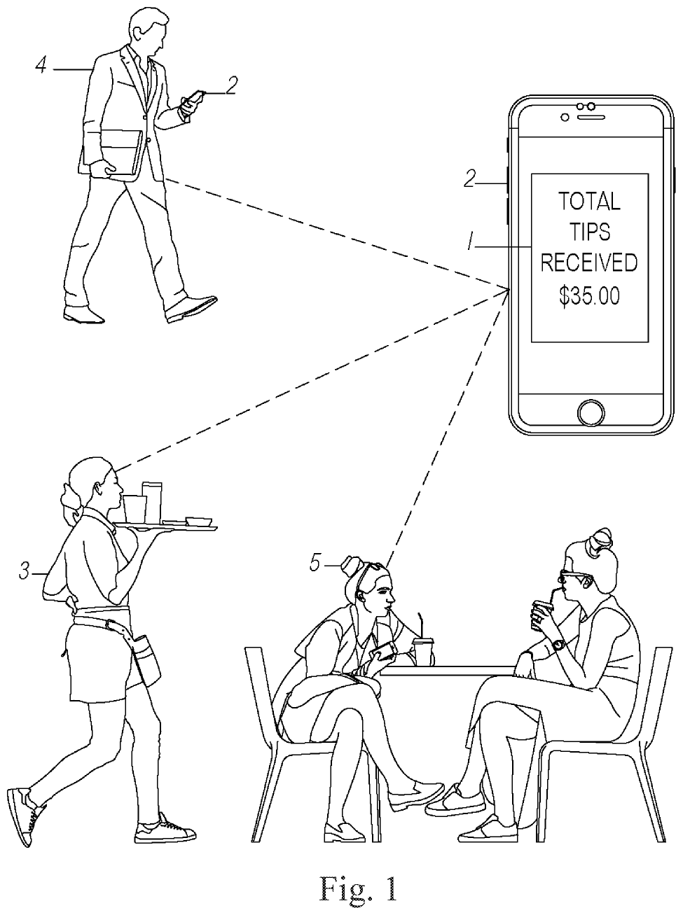

FIG. 1 shows perspective views of example embodiments of the invention in use with service provider 3, for example, receiving tips from customer 5 and employer 4 observing tip activity on smartphone 2 running the software application (app) of an example embodiment 1 thereon. In the example embodiment, the software application (app) 1 in combination with a data processor executing the app can be denoted as the ‘Daily Tip Payment System’ (DTPS). An example embodiment of the invention can include, but is not limited to, a software application, a data processor executing the app, a cloud network, and a website.

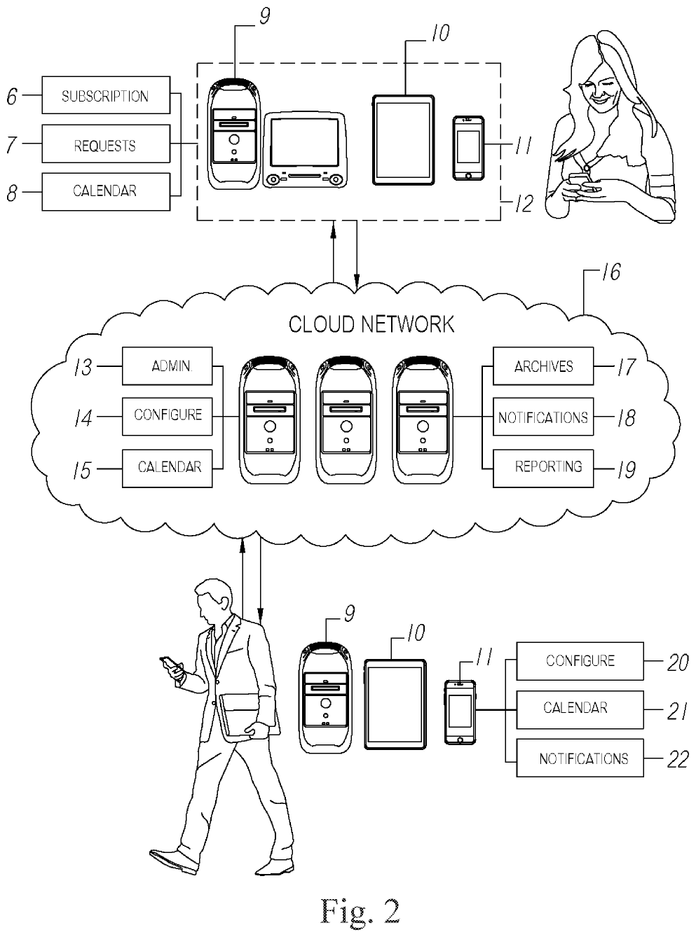

FIG. 2 illustrates the process operations of an example embodiment of the invention. A service provider having access to the DTPS software app of an example embodiments can perform a variety of functions or engage a variety of features, such as but not limited to: subscriptions 6 (e.g., entering demographics, account profile, website login information, tip deposit preferences, etc.); tip requests 7 (e.g., tip viewing, tip payout amounts, requesting tip collection times and dates etc.); and tip calendar 8 (e.g., viewing tip dispersal dates and times by day, week, month, etc.). The service provider may have access to the DTPS software app of an example embodiments by use of a range of computing devices 12, such as but not limited to, desktop computers 9, tablets 10, and smartphones 11, and the like. The employer having access to the DTPS software app of an example embodiments can perform a variety of functions or engage a variety of features, including a plurality of tip management operations, such as: configuration management 20 (e.g., assigning tip viewing rights to service providers, approving service provider tip payouts, linkages with existing point of sale (POS) software, approving tip tax withholding settings, etc.); setting up a tip payment calendar among service providers 21 (e.g., approving tip payout dispersion methods, dates and times etc.); reporting or notifications 22 (e.g., private viewing of service provider tip profiles, tips broken down by service provider in real time, and payout activity in real time, etc.). The service provider operations and employer functions can be serviced by a cloud network 16 having computer or software-implemented routines executing thereon, such routines including: administrative functions 13 (e.g., service provider and employer demographics and accounts, website backend management, existing POS linkages, employer subscription options, etc.); tip management configurations 14 (e.g., payout options, payout approvals, payout monitoring, tip monitoring settings, linkages with popular financial apps, etc.); tip calendar organization 15 (e.g., tip payout scheduling, tip schedule access rights, schedule editing rights, etc.); archives 17 (e.g., encrypted historical tip data available by service provider, customer, date and time etc.); notifications 18 (e.g., tip notifications via SMS, text, email etc., cash shortage forecasting alerts, etc.); and reporting 19 (e.g., year-end summary of tip activity listed by service provider, date, time etc., tip comparisons for performance evaluations etc.).

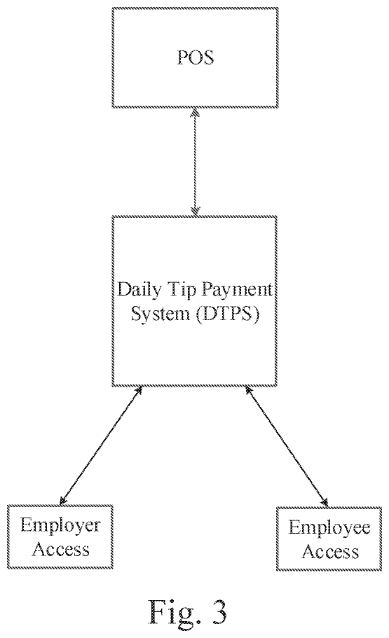

Referring now to FIG. 3, a system structure diagram illustrates an example embodiment represented as a Daily Tip Payment System (DTPS), executable by a data processor and in data communication with a POS and employer and employee access portals. In the example embodiment, the DTPS can be implemented as a data processing system and/or a software system implementing the features as disclosed herein. The DTPS can interface with a conventional POS system to receive tip and cash out information from the POS. The DTPS can also interface with employer and employee access portals (e.g., a mobile phone, website, or the like) to receive configuration parameters and to provide notifications to the employer or employee.

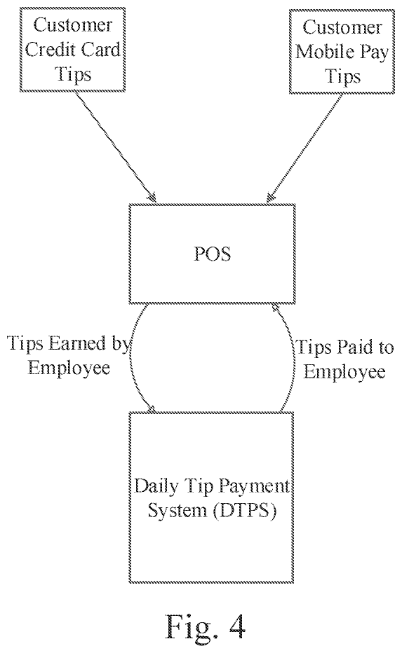

FIG. 4 illustrates a system structure diagram showing an example embodiment of the DTPS in data communication with a POS for receipt of tip information from the POS. In the example embodiment, the DTPS can support receipt of customer credit card tip information or customer mobile pay information via the POS. Additionally, the tip information can be conveyed to the DTPS and to an employee (e.g., via the employee access portal) as tips earned by the employee. The employee, or other service provider, can use the DTPS (e.g., via the employee access portal) to specify an amount of the received tips to be cashed out to the employee. This information can be conveyed from the DTPS to the POS as tips paid to the employee.

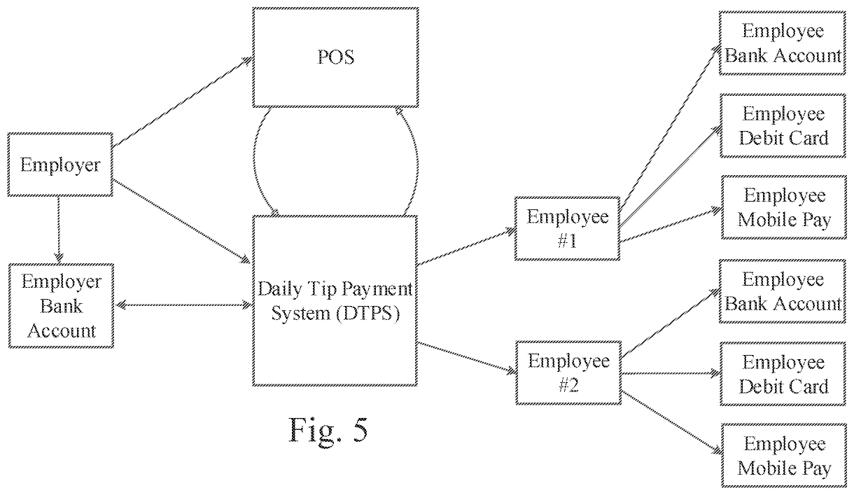

FIG. 5 illustrates a system structure diagram showing an example embodiment of the DTPS in data communication with a POS and providing data support for the employer and employees (or other service providers). In the example embodiment, the employer (e.g., via the employer access portal) can access the DTPS and cause or initiate a financial transaction to occur between the DTPS and a financial institution of the employer (e.g., the employer's account at a bank). In this manner, the employer can use an electronic fund transfer transaction, for example, to deposit tips received via the POS directly to the financial institution of the employer. As a result, the employer does not need to carry cash tips to the employer's bank for deposit. Moreover, when an employee wishes to cash out some or all of their received tips, the DTPS can cause a financial transaction to occur between the DTPS and a financial institution of the employer to directly transfer (e.g., via an electronic fund transfer) the employee's requested tip amount from the employer's financial institution to a financial receptacle of the employee. The employee's financial receptacle can be a bank account of the employee, the employee's debit card, the employee's mobile pay account, or other financial receptacle of the employee. The DTPS can handle the authentication and validation of the financial transactions.

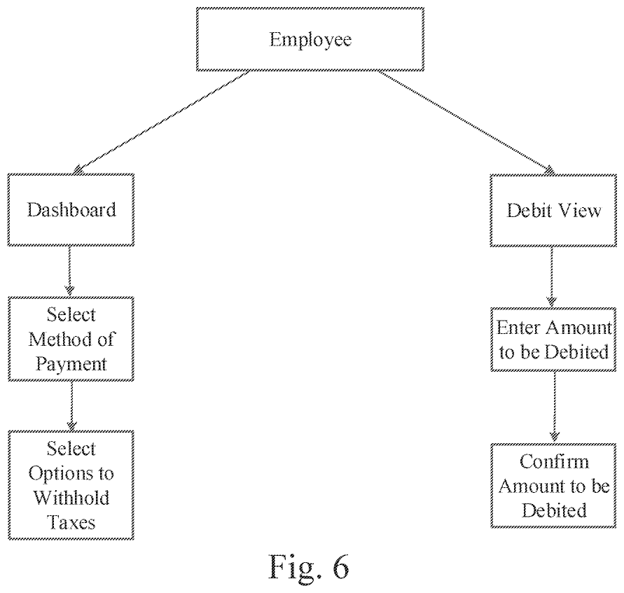

FIG. 6 illustrates a system structure diagram showing an example embodiment of the employee access portal or user interface provided by the DTPS. As shown, the employee, or other service provider, can use the employee access portal or user interface provided by the DTPS to access a dashboard or debit view. The dashboard enables the employee to configure or select a method of payment used by the DTPS to transfer a requested amount of the employee's tips to a financial receptacle of the employee. The employee can also configure or select an option to cause the DTPS to automatically withhold any taxes due on the tips paid out to the employee. As also shown in FIG. 6, the debit view presented to the employee by the employee access portal or user interface provided by the DTPS enables the employee to specify an amount of their tip allocation to be paid out and debited to their tip allocation. The specified tip amount can be transferred by the DTPS to a financial receptacle of the employee as described above. The debit view presented to the employee by the employee access portal or user interface provided by the DTPS can also prompt the employee to confirm the amount to be debited.

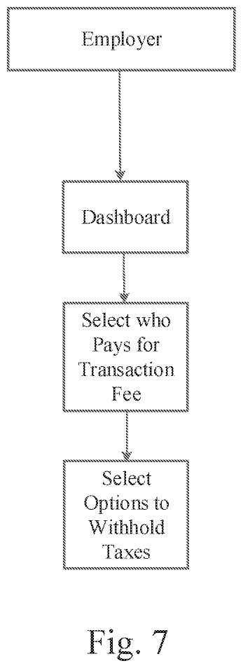

FIG. 7 illustrates a system structure diagram showing an example embodiment of the employer access portal or user interface provided by the DTPS. As shown, the employer can use the employer access portal or user interface provided by the DTPS to access a dashboard. The dashboard enables the employer to configure or select how the transaction fees related to the financial transactions are to be paid. The employer can also configure or select an option to cause the DTPS to automatically withhold any taxes due on the tips paid out to the employee.

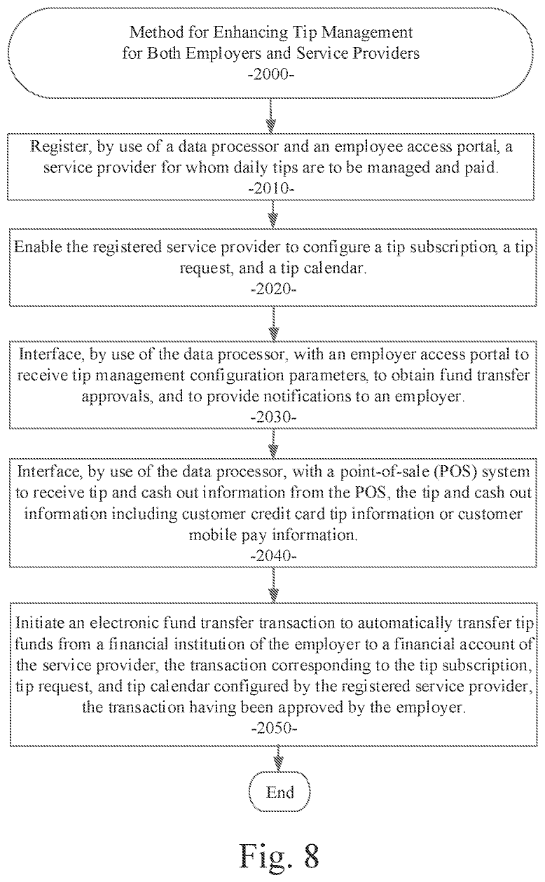

Referring now to FIG. 8, a processing flow diagram illustrates an example embodiment of a method implemented by the example embodiments as described herein. The method 2000 of an example embodiment can be configured to: register, by use of a data processor and an employee access portal, a service provider for whom daily tips are to be managed and paid (processing block 2010); enable the registered service provider to configure a tip subscription, a tip request, and a tip calendar (processing block 2020); interface, by use of the data processor, with an employer access portal to receive tip management configuration parameters, to obtain fund transfer approvals, and to provide notifications to an employer (processing block 2030); interface, by use of the data processor, with a point-of-sale (POS) system to receive tip and cash out information from the POS, the tip and cash out information including customer credit card tip information or customer mobile pay information (processing block 2040); and initiating an electronic fund transfer transaction to automatically transfer tip funds from a financial institution of the employer to a financial account of the service provider, the transaction corresponding to the tip subscription, tip request, and tip calendar configured by the registered service provider, the transaction having been approved by the employer (processing block 2050).

Those of ordinary skill in the art in view of the disclosure herein will recognize that mobile applications are written in several languages include, by way of non-limiting examples, C, C++, C#, Objective-C, Java, Javascript, Pascal, Object Pascal, Python, Ruby, VB.NET, WML, and XHL/HL with or without CSS, or combinations thereof. The app in example embodiments of the invention 1 is also compatible with a plurality of operating systems such as, but not limited to: Windows™, Apple™, and Android™, and compatible with a multitude of hardware platforms such as, but not limited to: personal desktops, laptops, tablets, smartphones and the like. Suitable mobile application development environments are available from several sources. Commercially available development environments include, by way of non-limiting examples, Airplay SDK™, alcheMo™, Appcelerator™, Celsius™, Bedrock™, Flash Lite™, .NET Compact Framework, Rhomobile™, and WorkLight™ Mobile Platform. Other development environments are available without cost including, by way of non-limiting examples, Lazarus™, MobiFlex™, MoSync™, and Phonegap™. Also, mobile device manufacturers distribute software developer kits including, by way of non-limiting examples, iPhone™ and iPad™ (iOS) SDK, Android™ SDK, BlackBerry™ SDK, BREW™ SDK, Palm™ OS SDK, Symbian™ SDK, webOS™ SDK, and Windows™ Mobile SDK. Those of ordinary skill in the art will recognize that several commercial forums are available for distribution of mobile applications including, by way of non-limiting examples, Apple™ App Store, Google™ Play, Chrome™ Web Store, BlackBerry™ App World, App Store for Palm™ devices, App Catalog for webOS™, Windows™ Marketplace for Mobile, Ovi™ Store for Nokia™ devices, Samsung™ Apps, and Nintendo™ DSi Shop.

In some embodiments, a computer program includes a standalone application, which is a program that is run as an independent computer process, not an add-on to an existing process, e.g., not a plug-in. Those of ordinary skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of ordinary skill in the art will be familiar with several web browser plug-ins including, Adobe™ Flash Player, Microsoft™ Silverlight, and Apple™ QuickTime.

In view of the disclosure provided herein, those of ordinary skill in the art will recognize that several plug-in frameworks are available that enable development of plug-ins in various programming languages, including, by way of non-limiting examples, C++, Delphi, Java™, PHP, Python, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft™ Internet Explorer, Mozilla™ Firefox, Google™ Chrome, Apple™ Safari, Opera™ Software Opera, and KDE Konqueror™. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google™ Android browser, RIM BlackBerry™ Browser, Apple™ Safari, Palm™ Blazer, Palm™ WebOS Browser, Mozilla™ Firefox for mobile, Microsoft™ Internet Explorer Mobile, Amazon™ Kindle Basic Web, Nokia™ Browser, Opera™ Software Opera Mobile, and Sony™ PSP™ browser.

In some embodiments, the platforms, systems, media, and methods disclosed herein include software, server, and/or database modules, or use of the same. In view of the disclosure provided herein, software modules are created by techniques known to those of ordinary skill in the art using machines, software, and languages known to the art. The software modules disclosed herein are implemented in a multitude of ways. In various embodiments, a software module comprises a file, a section of code, a programming object, a programming structure, or combinations thereof In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the systems and methods are shown in their most simple form, various components and aspects of the systems and methods may be differently shaped or slightly modified when forming the example embodiments of the invention as disclosed herein. As such those of ordinary skill in the art will appreciate the descriptions and depictions set forth in this disclosure and will understand that the disclosure herein is merely meant to portray examples of embodiments within the overall scope and intent of the invention, and are not to be considered limiting in any manner. While all of the fundamental characteristics and features of the example embodiments of the invention have been shown and described herein, with reference to particular embodiments thereof, a latitude of modification, various changes and substitutions are intended in the foregoing disclosure and it will be apparent that in some instances, some features of the example embodiments of the invention may be employed without a corresponding use of other features without departing from the scope of the example embodiments of the invention as set forth. It should also be understood that various substitutions, modifications, and variations may be made by those of ordinary skill in the art without departing from the scope of the invention.

What is claimed is:

1. A daily tip payment system, the system comprising:
a data processor; and
a daily tip payment application, executable by the data processor, the daily tip payment application being configured to:
register, by use of the data processor and an employee access portal, a service provider for whom daily tips are to be managed and paid;
enable the registered service provider to configure a tip subscription, a tip request, and a tip calendar;
interface, by use of the data processor, with an employer access portal to receive tip management configuration parameters, to obtain fund transfer approvals, and to provide notifications to an employer;
interface, by use of the data processor, with a point-of-sale (POS) system to receive tip and cash out information from the POS, the tip and cash out information including customer credit card tip information or customer mobile pay information; and
initiate an electronic fund transfer transaction to automatically transfer tip funds from a financial institution of the employer to a financial account of the service provider, the transaction corresponding to the tip subscription, tip request, and tip calendar configured by the registered service provider, the transaction having been approved by the employer.

2. The daily tip payment system of claim 1 wherein the tip subscription includes: demographics, account profile, website login information, and tip deposit preferences.

3. The daily tip payment system of claim 1 wherein the tip request includes: tip viewing preferences, tip payout amounts, and tip collection times and dates.

4. The daily tip payment system of claim 1 wherein the tip calendar includes: tip dispersal dates and tip dispersal times by day, week, and month.

5. The daily tip payment system of claim 1 wherein the employer access portal enables an employer to assign tip viewing rights to service providers, approve or disapprove service provider tip payouts, and approve or disapprove tip tax withholding settings.

6. The daily tip payment system of claim 1 wherein the notifications to the employer include private viewing of service provider tip profiles, tips broken down by service provider in real time, and payout activity in real time.

7. The daily tip payment system of claim 1 wherein the notifications to the employer include cash shortage forecasting alerts.

8. The daily tip payment system of claim 1 wherein the notifications to the employer are performed using SMS, text, or email.

9. The daily tip payment system of claim 1 being further configured to use an electronic fund transfer transaction to deposit tips received via the POS directly to the financial institution of the employer.

10. A method comprising:
registering, by use of a data processor and an employee access portal, a service provider for whom daily tips are to be managed and paid;
enabling the registered service provider to configure a tip subscription, a tip request, and a tip calendar;
interfacing, by use of the data processor, with an employer access portal to receive tip management configuration parameters, to obtain fund transfer approvals, and to provide notifications to an employer;
interfacing, by use of the data processor, with a point-of-sale (POS) system to receive tip and cash out information from the POS, the tip and cash out information including customer credit card tip information or customer mobile pay information; and
initiating an electronic fund transfer transaction to automatically transfer tip funds from a financial institution of the employer to a financial account of the service provider, the transaction corresponding to the tip subscription, tip request, and tip calendar configured by the registered service provider, the transaction having been approved by the employer.

11. The method of claim 10 wherein the tip subscription includes: demographics, account profile, website login information, and tip deposit preferences.

12. The method of claim 10 wherein the tip request includes: tip viewing preferences, tip payout amounts, and tip collection times and dates.

13. The method of claim 10 wherein the tip calendar includes: tip dispersal dates and tip dispersal times by day, week, and month.

14. The method of claim 10 wherein the employer access portal enables an employer to assign tip viewing rights to service providers, approve or disapprove service provider tip payouts, and approve or disapprove tip tax withholding settings.

15. The method of claim 10 wherein the notifications to the employer include private viewing of service provider tip profiles, tips broken down by service provider in real time, and payout activity in real time.

16. The method of claim 10 wherein the notifications to the employer include cash shortage forecasting alerts.

17. The method of claim 10 wherein the notifications to the employer are performed using SMS, text, or email.

18. The method of claim 10 including using an electronic fund transfer transaction to deposit tips received via the POS directly to the financial institution of the employer.

19. A non-transitory machine-useable storage medium embodying instructions which, when executed by a machine, cause the machine to:
register, by use of the data processor and an employee access portal, a service provider for whom daily tips are to be managed and paid;
enable the registered service provider to configure a tip subscription, a tip request, and a tip calendar;
interface, by use of the data processor, with an employer access portal to receive tip management configuration parameters, to obtain fund transfer approvals, and to provide notifications to an employer;
interface, by use of the data processor, with a point-of-sale (POS) system to receive tip and cash out information from the POS, the tip and cash out information including customer credit card tip information or customer mobile pay information; and
initiate an electronic fund transfer transaction to automatically transfer tip funds from a financial institution of the employer to a financial account of the service provider, the transaction corresponding to the tip subscription, tip request, and tip calendar configured by the registered service provider, the transaction having been approved by the employer.

20. The non-transitory machine-useable storage medium of claim 19 being further configured to use an electronic fund transfer transaction to deposit tips received via the POS directly to the financial institution of the employer.
